(19) United States
(12) Patent Application Publication
(10) Pub. No.: US 2023/0214623 A1
(43) Pub. Date: Jul. 6, 2023

(54) ELECTRONIC DEVICE AND METHOD FOR OPERATING ELECTRONIC DEVICE

(71) Applicant: InnoLux Corporation, Miao-Li County (TW)

(72) Inventor: Keiko EDO, Miao-Li County (TW)

(73) Assignee: InnoLux Corporation, Miao-Li County (TW)

(21) Appl. No.: 18/120,431

(22) Filed: Mar. 13, 2023

Related U.S. Application Data
(63) Continuation of application No. 17/211,781, filed on Mar. 24, 2021.

(51) Int. Cl. G06K 19/06

(52) U.S. Cl. CPC G06K 19/06112

(57) ABSTRACT

An electronic device including a processor and a display device is disclosed. The processor is configured to receive data and to generate at least one code according to an angular display algorithm. The at least one code includes an angular profile of the data. The display device is coupled to the processor and configured to receive the at least one code from the processor and to display the at least one code according to the angular profile. The angular profile includes a plurality of light intensities corresponding to a plurality of viewing angles. A number of the at least one code is adjusted according to a security of the data, and when the number of the at least one code increases, the number of the plurality of viewing angles to display the at least one code increases.

### CROSS REFERENCE TO RELATED APPLICATIONS

This application is a continuation application of U.S. application Ser. No. 17/211,781, filed on Mar. 24, 2021. The content of the application is incorporated herein by reference.

### BACKGROUND OF THE DISCLOSURE

### 1. Field of the Disclosure

The present disclosure is related to an electronic device and a method of generating codes, and more particularly, to an electronic device capable of displaying codes via different viewing angles.

### 2. Description of the Prior Art

Bar codes and quick response (QR) codes are widely used in various applications. However, the amount of storage of a single bar code or a single QR code is limited, which leads to a low security of the data included in the codes. Therefore, how to increase the amount of storage and how to improve the security of the codes are important problems to be solved.

### SUMMARY OF THE DISCLOSURE

An embodiment of the present disclosure discloses an electronic device including a processor and a display device. The processor is configured to receive data and to generate at least one code according to an angular display algorithm. The at least one code includes an angular profile of the data. The display device is coupled to the processor and configured to receive the at least one code from the processor and to display the at least one code according to the angular profile. The angular profile includes a plurality of light intensities corresponding to a plurality of viewing angles. A number of the at least one code is adjusted according to a security of the data, and when the number of the at least one code increases, the number of the plurality of viewing angles to display the at least one code increases.

Another embodiment of the present disclosure discloses a method for operating an electronic device. The electronic device includes a processor and a display device, and the display device includes a storage device, at least one pixel array, a controller and an optical modulator. The method includes the processor receiving data and generating at least one code including an angular profile of the data, wherein the angular profile includes a plurality of light intensities corresponding to a plurality of viewing angles and the processor generates the at least one code according to an angular display algorithm; the storage device receiving the at least one code from the processor; and the controller controlling the at least one pixel array to allow the display device to display the at least one code via the plurality of viewing angles. A number of the at least one code is adjusted according to a security of the data, and when the number of the at least one code increases, the number of the plurality of viewing angles to display the at least one code increases.

An embodiment of the present disclosure discloses an electronic device including an encoder and a display device. The encoder receives data and generates at least one code including an angular profile of the data. The display device is coupled to the encoder and configured to receive the at least one code from the encoder and to display the at least one code according to the angular profile.

An embodiment of the present disclosure discloses a method for operating an electronic device, the electronic device including an encoder and a display device, the display device including a storage device, at least one pixel array, a controller and an optical modulator. The method includes the encoder receiving data and generating at least one code including an angular profile of the data; the storage device receiving the at least one code from the encoder; and the controller controlling the at least one pixel array to allow the display device to display the at least one code via a plurality of viewing angles in the angular profile.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 shows an electronic device according to the embodiment of the present disclosure.

FIG. 2 shows a composition of the at least one code according to the embodiment of the present disclosure.

FIG. 3 shows a display device according to the embodiment of the present disclosure.

FIG. 4 shows a flow chart of a method for operating the electronic device in accordance with the embodiments of the present disclosure.

### DETAILED DESCRIPTION

The present disclosure may be understood by reference to the following detailed description, taken in conjunction with the drawing as described below. It is noted that, for purposes of illustrative clarity and being easily understood by the readers, various drawings of this disclosure show a portion of the display device, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As those skilled in the art will understand, electronic equipment manufacturers may refer to a component by different names. This document does not intend to distinguish between components that differ in name but not function.

In the description and the claims, the terms “include”, “comprise” and “have” are used in an open-ended fashion, and thus should be interpreted to mean “include but not limited to . . . ”.

It will be understood that when an element or layer is referred to as being “on” or “coupled to” another element or layer, it can be directly on or directly coupled to the other element or layer, or intervening elements or layers may be presented. In contrast, when an element is referred to as being “directly on” or “directly coupled to” another element or layer, there are no intervening elements or layers presented.

It should be noted that the technical features in different embodiments described in the following can be replaced, recombined, or mixed with one another to constitute another embodiment without departing from the spirit of the present disclosure.

One advantage of the electronic device of the present disclosure is displaying at least one code via different viewing angles at a same time. Each of the at least one code may be scanned (or detected) via a corresponding viewing angle. Compared with conventional electronic devices that show the same code via different viewing angles, the electronic device of the present disclosure can show multiple codes at a same time, and the amount of storage information provided by the at least one code is increased. In addition, since each of the at least one code may be scanned via a corresponding viewing angle, the security of the at least one code is improved.

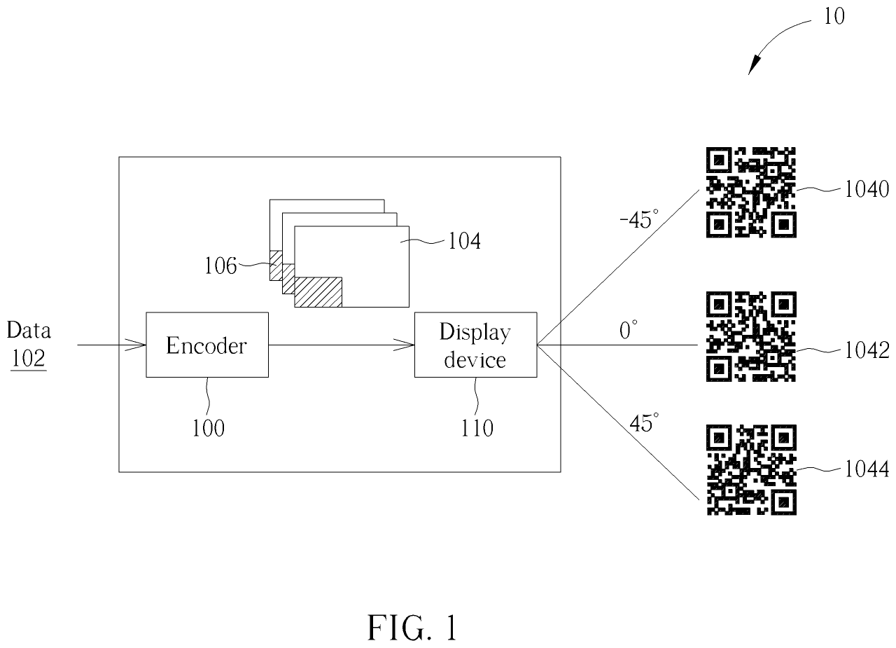

FIG. 1 shows an electronic device 10 according to the embodiment of the present disclosure. The codes system may include an encoder 100 and a display device 110. The encoder 100 may be configured to receive data 102 and to generate at least one code 104 including an angular profile 106 of the data 102. The display device 110 may be coupled to the encoder 100, and may be configured to display the at least one code 104 according to the angular profile 106. The display device 110 may show the angular profile 106 such that the at least one code 104 may be scanned (or detected) via corresponding viewing angle(s).

In the present embodiment, for example, the encoder 100 may generate three codes (i.e., the at least one code 104) according to the data 102, but not limited thereto. The codes may include a code 1040, a code 1042 and a code 1044. The display device 110 displays the codes via viewing angles of −45°, 0° and 45°, respectively, at a same time. When a scanner scans the codes via the viewing angle of −45°, only the code 1040 may be detected while the other two codes (i.e., the code 1042 and the code 1044) are not detected. Similarly, the code 1042 may be detected via only the viewing angle of 0°, and the code 1044 may be detected via only the viewing angle of 45°. In some embodiments, the codes may be displayed at the same position of the display device at the same time, and the scanner may scan the codes via corresponding viewing angles, but not limited thereto. Thus, comparing with an electronic device can only shows a code at a same time, the amount of storage information is increased according to the present disclosure. It is noted that the numbers of the codes and the viewing angles are only for exemplary illustration. People having skills in the art may determine the numbers according to the design requirement. For example, the number of the codes may be ranged from 2 to 10, such as 3, 5 or 7, but not limited thereto. The viewing angles may be ranged from 75° to −75°, such as 0°, 30°, 60°, −30° or −60°, but not limited thereto. After scanning the codes, the user may obtain the information, such as electronic tickets, personal profiles or other suitable information. The viewing angle 0° may be defined as viewing the display device 110 directly in front of the display device 110.

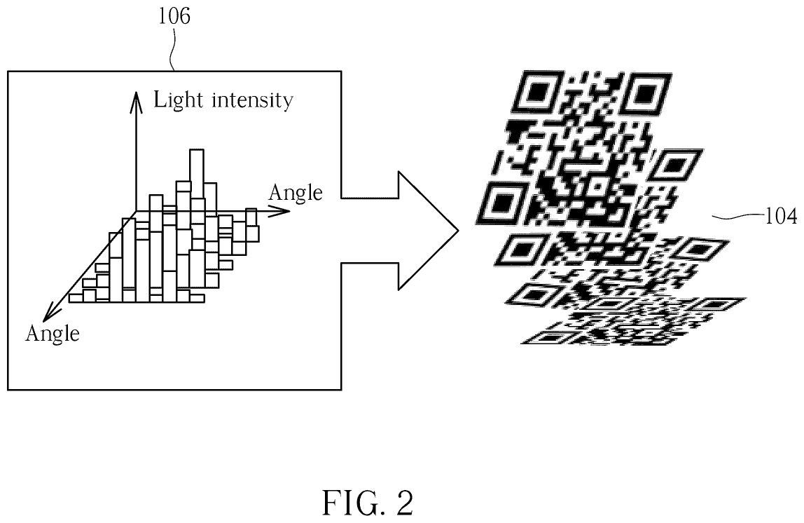

FIG. 2 shows a composition of the at least one code 104 according to the embodiment of the present disclosure. The at least one code 104 may include information of the data 102 and the angular profile 106. The angular profile 106 may include a plurality of light intensities corresponding to a plurality of viewing angles, but not limited thereto. After receiving the data 102 (as shown in FIG. 1), the encoder 100 may generate the at least one code 104 including the angular profile 106. The at least one code 104 may increase the storage of the information and/or improve the security of the data 102.

In an embodiment, the angular profile 106 may include position information, color information, depth information and a plurality of viewing angles of the data 102. In an embodiment, the angular profile 106 may further include a plurality of lighting profiles (e.g., light intensity) corresponding to the plurality of viewing angles. That is, a first code (e.g., the code 1042) at a first viewing angle (e.g., 0°) may be changed into a second code (e.g., the code 1044) at a second viewing angle (e.g., 45°) by changing the angular profile 106. For example, the light intensity and/or the color information of at least a portion of the first code may be changed (e.g., from white to black or from black to white) when the corresponding viewing angle is changed, but not limited thereto.

In an embodiment, the data 102 may include a bar code (i.e., one dimensional (1D) code), a quick response (QR) code (i.e., two dimensional (2D) code) or a three dimensional (3D) code, but not limited thereto. In this case, the encoder 100 may generate the at least one code 104 by adding the angular profile 106 to the data 102. To obtain the full information of the data 102, the at least one code 104 may be scanned via different viewing angles, and the security of the data 102 is improved. In some embodiments, a piece of information may be transferred into the data 102. Then, the encoder 100 may encode the data 102 into the at least one code 104.

In an embodiment, the at least one code 104 may include at least one bar code, at least one QR code, at least one 3D code, other suitable codes, or a combination thereof, but not limited thereto. Thus, the at least one code 104 may be generated in different forms, but not limited thereto.

In an embodiment, the at least one code 104 is generated according to an angular display algorithm. In the field of image processing, the angular display algorithm may be applied to display an object on a scene. Different colors and/or different light intensities (included in the angular profile) on the same object are shown at different positions (or via different viewing angles). In the present disclosure, the angular display algorithm is applied to display the at least one code 104 such that different codes with different colors (e.g., black and white) and/or different light intensities can be scanned (or detected) via different viewing angles.

In an embodiment, the encoder 100 may generate dummy code included in the at least one code 104. The dummy code may not include any information of the data 102. The number of the at least one code 104 increases due to the dummy code, which may improve the security of the at least one code 104.

In an embodiment, a number of the at least one code 104 can be adjusted according to an amount of the data 102, a security of the data 102 or other requirements, but not limited thereto. When the number of the at least one code 104 increases, a number of the plurality of viewing angles to display the at least one code 104 may also increase. For example, assume that the encoder 100 generates five codes (e.g., the at least one code 104) according to the data 102, and the five codes may be displayed via viewing angles of −60°, −30°, 0°, 30° and 60°, respectively. If the data 102 includes more information or a higher security of the data 102 is required, the encoder 100 may generate, for example, nine codes (e.g., the at least one code 104) according to the data 102. The nine codes may be displayed via viewing angles of −60°, −45°, −30°, −15°, 0°, 15°, 30°, 45° and 60°, respectively.

In an embodiment, a definition of the at least one code 104 may be the same as that of the bar code, the QR code or the 3D code. That is, the at least one code 104 can be scanned with the use of current scanning system, but are displayed by a specific display device such that the at least one code 104 can be displayed via different viewing angles.

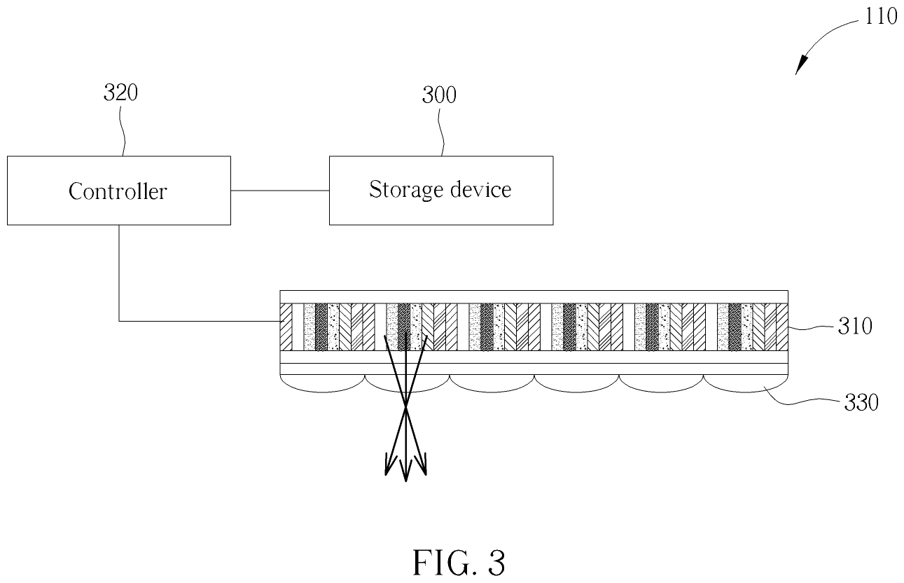

FIG. 3 is a display device 110 according to an embodiment of the present disclosure. The display device 110 may include a public information display device, an automobile display device, a business exhibition display device, or other suitable display device, but not limited thereto. The display device 110 may include a storage device 300, at least one pixel array 310, a controller 320 and an optical modulator 330.

In an embodiment, the storage device 300 may receive and store the at least one code 104 generated by the encoder 100. In some embodiments, the storage device 300 may store the angular profile 106.

In an embodiment, the at least one pixel array 310 may be configured to display the at least one code 104. In an embodiment, the at least one pixel array 310 may include a display module and/or a backlight module emitting light to the display module. In some embodiments, the at least one pixel array 310 may include the display module but not include the backlight module. For example, the display module may include a light-emitting diode (LED) display module, but not limited thereto. For example, the display module may include a liquid crystal (LC), an LED, an organic LED (OLED), a mini LED, a micro LED, a quantum dot, a fluorescence, a phosphor, a display medium of other kinds, or a combination thereof. The backlight module may include a plurality of mini LEDs or a plurality of micro LEDs. However, the present disclosure is not limited thereto.

In an embodiment, the controller 320 may be coupled to the storage device 300 and the at least one pixel array 310, and may be configured to control the at least one pixel array 310 to allow the display device 110 to display the at least one code 104 via the plurality of viewing angles. In other words, the controller 320 may generate a plurality of images for the at least one code 104 with different colors and/or light intensities corresponding to the plurality of viewing angles. Then, the display device 110 may display the plurality of images (e.g., the at least one code 104) via the plurality of viewing angles through the at least one pixel array 310 and the optical modulator 330 at a same time.

In an embodiment, the optical modulator 330 may be disposed on the at least one pixel array 310, and may be able to modulate the light emitted from the at least one pixel array 310 to the plurality of viewing angles. The optical modulator 330 may include, for example but not limited to, a lenticular lens, a LC grin lens, a parallax barrier, a LC parallax barrier, other suitable optical components that can modulate the light, or a combination thereof. In other embodiments, the optical modulator 330 may be disposed between the display module and the backlight module, but not limited thereto.

In an embodiment, the display device 110 may be, but not limited to, a stacked display type (e.g., a display module may include at least two display panels), a projector type or a reflective light field type.

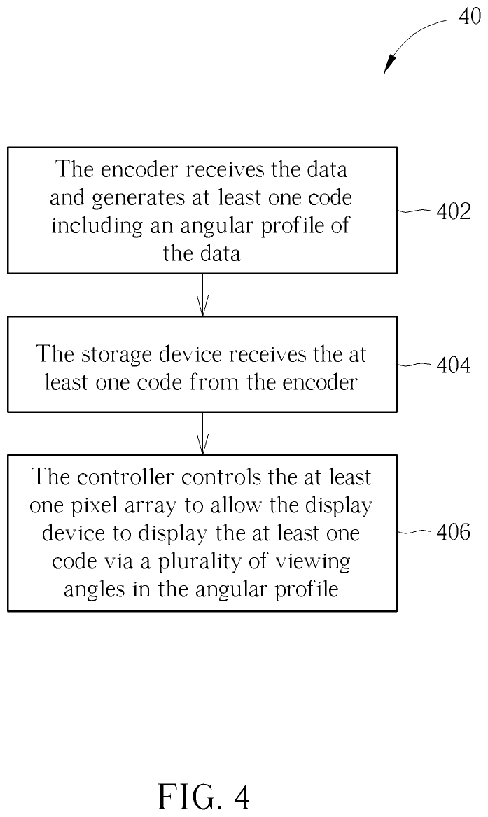

FIG. 4 shows a flow chart of a method 40 for operating the electronic device 10 in accordance with the embodiments of the present disclosure. It is noted that some steps may be omitted or added to constitute another embodiment of the present disclosure. The method 40 may include the following steps:

Step 402: The encoder 100 receives the data 102 and generates at least one code 104 including an angular profile 106 of the data 102.

Step 404: The storage device 300 receives the at least one code 104 from the encoder 100.

Step 406: The controller 320 controls the at least one pixel array 310 to allow the display device 110 to display the at least one code 104 via a plurality of viewing angles in the angular profile 106.

In an embodiment, the at least one pixel array 310 may display an image, and the optical modulator 330 may modulate the image to allow the display device 110 to display the at least one code 104 via a plurality of viewing angles, but not limited thereto. For example, the scanner may not recognize the image when the optical modulator is absent.

In summary, the electronic device and the method for operating the electronic device provided by the embodiments of the present disclosure can display the at least one code via the plurality of viewing angles according to the angular profile of the data. Therefore, the amount of information that can be displayed at a same time is increased. In addition, the security of the codes is improved. Thus, the problem in the art is solved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a processor, configured to receive data and to generate at least one code according to an angular display algorithm, wherein the at least one code comprises an angular profile of the data; and
a display device, coupled to the processor, configured to receive the at least one code from the processor and to display the at least one code according to the angular profile, wherein the angular profile comprises a plurality of light intensities corresponding to a plurality of viewing angles,
wherein a number of the at least one code is adjusted according to a security of the data, and when the number of the at least one code increases, the number of the plurality of viewing angles to display the at least one code increases.

2. The electronic device of claim 1, wherein the at least one code further comprises a dummy code, and the dummy code does not comprise information of the data.

3. The electronic device of claim 1, wherein the display device displays the at least one code via the plurality of viewing angles at a same position of the display device.

4. The electronic device of claim 1, wherein the data comprises a bar code, a quick response (QR) code or a three dimensional (3D) code.

5. The electronic device of claim 1, wherein the at least one code comprises at least one bar code, at least one QR code or at least one 3D code.

6. The electronic device of claim 1, wherein the display device comprises:
at least one pixel array;
an optical modulator, disposed on the at least one pixel array;
a storage device, configured to receive the at least one code; and
a controller, coupled to the storage device and the at least one pixel array, configured to control the at least one pixel array to allow the display device to display the at least one code via the plurality of viewing angles.

7. A method for operating an electronic device, the electronic device comprising a processor and a display device, the display device comprising a storage device, at least one pixel array, a controller and an optical modulator, and the method comprising:
the processor receiving data and generating at least one code comprising an angular profile of the data, wherein the angular profile comprises a plurality of light intensities corresponding to a plurality of viewing angles and the processor generates the at least one code according to an angular display algorithm;
the storage device receiving the at least one code from the processor; and
the controller controlling the at least one pixel array to allow the display device to display the at least one code via the plurality of viewing angles,
wherein a number of the at least one code is adjusted according to a security of the data, and when the number of the at least one code increases, the number of the plurality of viewing angles to display the at least one code increases.

8. The method of claim 7, wherein the at least one code further comprises a dummy code, and the dummy code does not comprise information of the data.

9. The method of claim 7, wherein the optical modulator modulates light emitted from the at least one pixel array to allow the display device to display the at least one code via the plurality of viewing angles.

10. The method of claim 7, wherein the at least one code comprises at least one bar code, at least one QR code or at least one 3D code.
